(19) United States
(12) Patent Application Publication
(10) Pub. No.: US 2020/0310156 A1
(43) Pub. Date: Oct. 1, 2020

(54) Eyewear With Multiple Fastening Mechanism

(71) Applicants: Chien Ho Lin, Chaiyi (TW); David B. Schottenstein, Surfside, FL (US)

(72) Inventors: Chien Ho Lin, Chaiyi (TW); David B. Schottenstein, Surfside, FL (US)

(73) Assignee: Prive Goods LLC, Aventura, FL (US)

(21) Appl. No.: 16/372,125

(22) Filed: Apr. 1, 2019

(51) Int. Cl. G02C 3/04; G02C 5/14; A45F 5/02

(52) U.S. Cl. CPC G02C 3/04; G02C 5/14; A45F 2200/0541; G02C 2200/02; A45F 5/02

(57) ABSTRACT

An eyewear with a multiple fastening mechanism, the multiple fastening mechanism comprising two or more fastening means in contact with, or attached to, a first and second temple of the eyewear. Each of the two or more pairs of fastening means comprises a first part in contact with, or attached to, the first temple and a second part in contact with, or attached to, the second temple. The first and second part of the two or more pairs of fastening means are located at approximately the same place on the first and second temple, respectively, such that they align when the temples are pivoted to a closed position, thereby forming a stable fastening mechanism.

### FIELD OF THE INVENTION

This invention generally relates to eyewear with a multiple fastening mechanism, the multiple fastening mechanism comprising two or more fastening means in contact with, or attached to, a first and second temple of the eyewear. In particular, each of the two or more pairs of fastening means comprises a first part of the two or more pairs of fastening means in contact with, or attached to, the first temple and a second part of the two or more pairs of fastening means in contact with, or attached to, the second temple. The first and second part of the two or more pairs of fastening means are located at approximately the same place on the first and second temple, respectively, such that they align when the temples are pivoted to a closed position, thereby forming a fastening mechanism. As such, when the fastening mechanism is activated, the eyewear can be securely fastened to a separate article, such as a user's article of clothing.

### BACKGROUND OF THE INVENTION

Conventional eyewear includes a frame for housing two lenses, and two temples, or arms, that are attached to the frame and extend perpendicular to the same when in the open position. The temples are pivotally coupled to the frame about a device such as a hinge, providing a means for the temples to pivot to a closed position parallel to the frame. Alternatively, the temples are integrally formed with the frame, wherein the temples are provided with a corrugated surface on the inner side near the frame such that the temples can be folded (or placed in the closed position) upon application of force.

Eyewear users, particularly those that wear reading glasses or sunglasses, typically remove the eyewear with regularity. The user is then left with the options of temporarily placing the eyewear on a flat surface (while in the open position) or inside a part of an article of clothing (while in the closed position), such as a pocket; storing the eyewear in a case or pouch; or hanging the eyewear around the neck by way of means of connecting the two temples. All of these options present the user with obstacles, including inconvenience to the user and misplacement of and/or damage to the eyewear. For these reasons, users often “hang” the eyewear from a part of an article of clothing, such as a shirt or pant pocket or the neck of a shirt. However, this presents the user with the unintentional consequence of the eyewear falling out of the part of article of clothing when running, jumping or simply bending over.

U.S. Pat. No. 6,848,787 to Dietz discloses a magnetic eyewear clasp for maintaining the eyewear on a clothing material. Similarly, U.S. 2018/0129067 to Boedecker et al. teaches a magnetic fastening mechanism wherein the magnetic force is sufficient enough to keep the temples of the eyewear closed and clasped to an article of clothing. Both the '787 patent and the '067 published patent application disclose a pair of magnets, one magnet in each of the temples, aligned with each other when the eyewear is in the closed position. While the single-pair magnetic fastener is an improvement over mechanical clasps, the magnetic force generated from a single pair of magnets is sometimes not adequate when the eyewear is in the closed position over, for example, a thicker area of clothing.

There therefore still exits a need for eyewear with an improved fastening device to correct the deficiencies of the prior art. In particular, the eyewear disclosed herein provides a user with a multiple fastening mechanism for increased force for when the eyewear is in the closed position, the multiple fastening mechanism comprising two or more pairs of fastening means in the temples of the eyewear, wherein a first part of each pair of the fastening means is in a first temple and a second part of each pair of the fastening means is in a second temple.

### SUMMARY OF THE INVENTION

In light of the foregoing, it is an object of the present invention to provide an eyewear, such as sunglasses, reading glasses and the like, with a multiple fastening mechanism, the multiple fastening mechanism comprising two or more pairs of fastening means attached to each temple of the eyewear, wherein a first part of each of the two or more pairs of fastening means is attached to or in contact with a first temple, and a second part of each of the two or more pairs of fastening means is attached to or in contact with a second temple. The first and second part of the two or more pairs of fastening means are located at approximately the same place on the first and second temple, respectively, such that they align when the temples are pivoted to a closed position, thereby forming a fastening mechanism. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can also be an object of the present invention to provide an eyewear comprising a frame body for receiving two lenses, a first temple pivotally attached to a first end of the frame, a second temple pivotally attached to a second end of the frame, and a multiple fastening mechanism comprising two or more pairs of fastening means, wherein a first part of each of the two or more pairs of fastening means is attached to or in contact with the first temple and a second part of each of the two or more pairs of fastening means is attached to or in contact with the second temple. Each first part of each of the two or more pairs of fastening means is configured to be positioned adjacent to each second part of each of the two or more pairs of fastening means such that a closing force is exerted on each pair of fastening means relative to each first part and each second part of each two or more pair of fastening means when the first and second temples are pivoted inwardly to a closed position.

In part, it is further an object of the invention to provide an eyewear comprising a frame body for receiving two lenses, a first temple pivotally attached to a first end of the frame, a second temple pivotally attached to a second end of the frame, and a multiple fastening mechanism comprising two or more pairs of magnets, wherein each of the two or more pairs of magnets comprises a first magnet attached to or in contact with the first temple and a second magnet attached to or in contact with the second temple. Each first magnet is configured to be positioned adjacent to each second magnet such that a closing force is exerted on each of the two or more pairs of magnets when the first and second temples are pivoted inwardly to a closed position.

In part, it is further an object of the invention to provide a method of supporting eyewear on an article of clothing of a user, the method comprising 1) providing eyewear comprising a frame body for receiving two lenses, a first temple pivotally attached to a first end of the frame, a second temple pivotally attached to a second end of the frame, and a multiple fastening mechanism comprising two or more pairs of magnets, wherein each of the two or more pairs of magnets comprises a first magnet attached to or in contact with the first temple and a second magnet attached to or in contact with the second temple; 2) contacting the first temple to an inside portion of the article of clothing; and 3) contacting the second temple on an outside portion of the article of clothing; wherein the moving of step 2) and the moving of step 3) collectively provides that the first and second temples are pivoted inwardly towards each other to a closed position and each first magnet is configured to be positioned adjacent to each second magnet such that a closing force is exerted on each of the two or more pairs of magnets, thereby supporting the eyewear to the article of clothing of the user.

Other objects, features, benefits and advantages of the present invention will be apparent from this summary and the following descriptions of certain embodiments and will be readily apparent to those skilled in the art having knowledge of various eyewear with fastening mechanism. Such objects, features, benefits and advantages will be apparent from the above as taken into conjunction with the accompanying examples, figures and all reasonable inferences to be drawn therefrom. The disclosures in this application of all articles and references, including patents, are incorporated herein by reference.

### BRIEF DESCRIPTION OF THE DRAWINGS

FIG. 1 depicts a top view of eyewear incorporating a multiple fastening mechanism with the temples pivoted inwardly to the closed position.

FIG. 2 depicts a side view of the eyewear of FIG. 1 incorporating a multiple fastening mechanism with the temples pivoted outwardly to the open position.

FIG. 3 is a perspective view of the eyewear of FIG. 1 incorporating a multiple fastening mechanism.

FIG. 4 is a perspective view of eyewear clasped to a zipper of an article of clothing; FIG. 4A shows eyewear with a single fastening mechanism clasped to the zipper, FIG. 4B shows eyewear with a multiple fastening mechanism stabilized while clasped to the zipper.

FIG. 5 is a perspective view of eyewear clasped to a thick area of an article of clothing; FIG. 5A shows eyewear with a single fastening mechanism clasped to the thick area of the article of clothing; FIG. 5B shows eyewear with a multiple fastening mechanism stabilized while clasped to the thick area of the article of clothing.

FIG. 6 illustrates the difference between eyewear with a single fastening mechanism and eyewear with a multiple fastening mechanism, each clasped to a zipper of an article of clothing; FIG. 6A shows how the thickness of the zipper forces the single fastening mechanism to disengage and therefore rotate the eyewear about the zipper, FIG. 6B shows the stability of the multiple fastening mechanism about the zipper of the article of clothing.

### DETAILED DESCRIPTION OF INVENTION

As it relates to certain non-limiting embodiments, the present invention relates to eyewear with a multiple fastening mechanism, the multiple fastening mechanism comprising two or more pairs of fastening means attached to each temple of the eyewear, wherein a first part of each of the two or more pairs of fastening means is attached to or in contact with a first temple, and a second part of each of the two or more pairs of fastening means is attached to or in contact with a second temple.

As used herein, “eyewear” is an object worn in front of each eye, such as but not limited to, eyeglasses, sunglasses and the like. As discussed in detail below in the specific non-limiting embodiments of the invention, the eyewear preferably comprises a frame for housing or receiving two lenses. The lenses are made of a piece of glass or other transparent substance with curved sides for concentrating or dispersing light and are used to correct or assist defective eyesight and/or protect the eyes from, for example, UV light. The frame preferably includes a nose piece. The eyewear also comprises a first temple and a second temple pivotally connected or attached to a first end and a second end, respectively, of the frame. Preferably, the pivotal connection or attachment is a pin member or a hinge, such as but not limited to a barrel hinge (or standard hinge) and spring action hinge. More preferably, the pivotal connection or attachment is a hinge. Alternatively, eyewear is made of an elastic material and the temples are integrally formed with the frame, the temples provided with, for example, a corrugated surface such that they fold or bend smoothly to a closed position by applying force. The temples terminate at an opposite end from the pivotal connection or attachment into an earpiece.

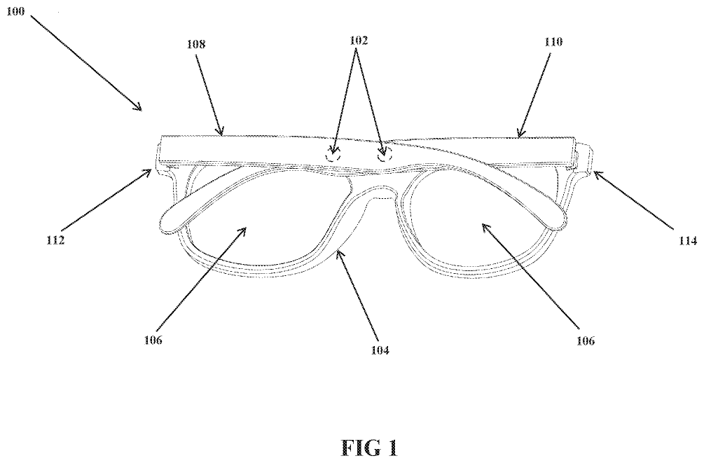

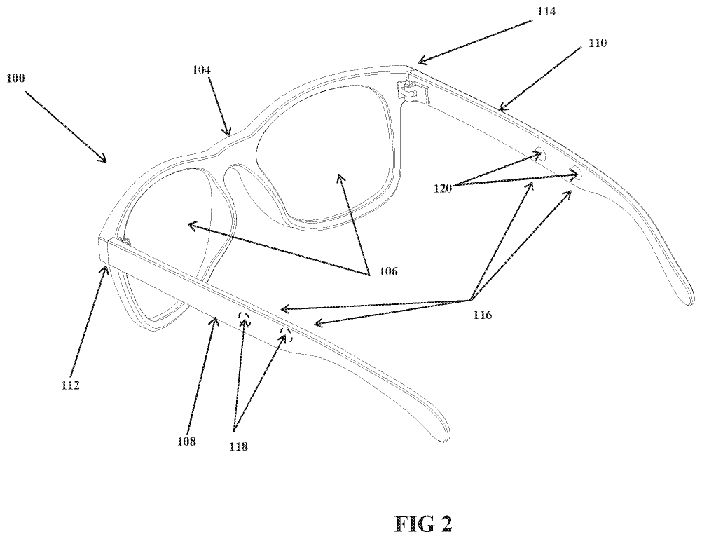

Referring now to the specific non-limiting embodiments of the invention, FIG. 1 depicts a top view of eyewear 100 incorporating a multiple fastening mechanism 102 with the temples 108, 110 pivoted inwardly to the closed position. The eyewear 100 comprises a frame body (or frame) 104 for housing two lenses 106, a first temple 108 pivotally attached to or integrally part of a first end of the frame 112, a second temple 110 pivotally attached to or integrally part of a second end of the frame 114, and a multiple fastening mechanism 102. Referring now to FIG. 2, which depicts the eyewear 100 of FIG. 1 incorporating the multiple fastening mechanism 102 with the first and second temples 108, 110 pivoted outwardly to the open position, the multiple fastening mechanism 102 further comprises two or more pairs of fastening means 116, wherein a first part 118 of each of the two or more pairs of fastening means 116 is attached to or in contact with the first temple 108 and a second part 120 of each of the two or more pair of fastening means 116 is attached to or in contact with the second temple 110. Each first part 118 of each of the two or more pairs of fastening means 116 is configured to be positioned adjacent to each second part 120 of each of the two or more pairs of fastening means 116 such that a closing force is exerted on each pair of fastening means 116 relative to each first part 118 and each second part 120 of each two or more pairs of fastening means 116 when the first and second temples 108, 110 are pivoted inwardly to a closed position (see FIG. 1).

The two or more pairs of fastening means 116 as illustrated in FIG. 1 and FIG. 2 can be mechanical or magnetic, so long as the first part 118 aligns with or is configured to the second part 120 such that they engage or otherwise provide a closing force on each pair of fastening means 116 relative to each first part 118 and each second part 120. Preferably, the two or more pairs of fastening means 116 comprise a first magnet 118 attached to or in contact with the first temple 108 and a second magnet 120 attached to or in contact with the second temple 110. Each first magnet 118 is configured to be positioned adjacent to each second magnet 120 such that a closing force is exerted on each of the two or more pairs of magnets 116 when the first and second temples 108, 110 are pivoted inwardly to a closed position. As used herein, when referring to the magnets as “attached to or in contact with” the temples, the magnets can be press-fit, friction-fit, interference-fit, adhered, heat-shrink tubed, molded, or otherwise secured to, mounted on, engaged with, integrated into, or in contact with the temples by any known method. Preferably, the magnets are integrated into the temples, such as but not limited to, integrally molding the magnets into the temples, the magnets being thin enough to integrally fit within the temples. The magnets can take on various shapes, such as circular or rectangular and the like.

As defined herein, a “magnet” is a material (magnetic material) or object that produces a magnetic field. A magnet's magnetic moment is a vector that characterizes the magnet's overall magnetic properties. The direction of the magnetic moment of a magnet points from the magnet's south pole to its north pole, and the magnitude relates to how strong and how far apart these poles are. A magnetic material is any material that is capable of being attracted by or acquiring the properties of a magnet to attract magnetic materials. This includes ferromagnets (magnets including iron) as well as non-ferrous magnets. Some examples of magnetic materials are, but are not limited to, neodymium, steel, nickel, cobalt, an aluminum-nickel-cobalt alloy (alnico), an alloy of rare earth metals, and naturally occurring minerals such as lodestone.

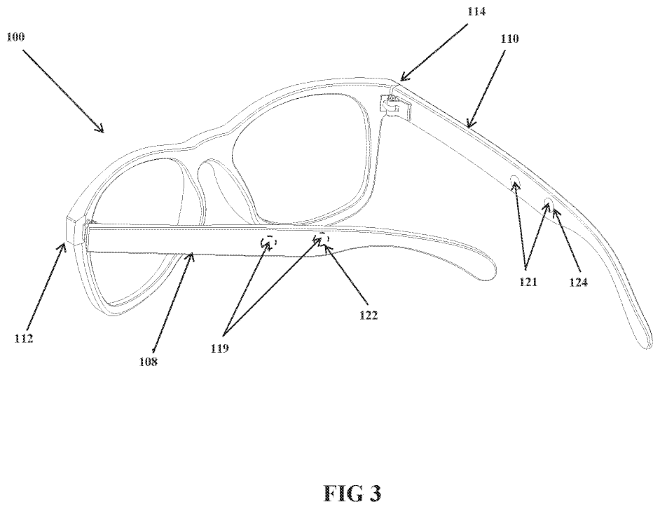

It is to be understood by those skilled in the art that the first and second magnets 118, 120 are axially magnetized such that a north pole of the first magnet 118 and a south pole of the second magnet 120 (or visa versa) are directed in opposite directions. Generally speaking, opposite poles of magnets attract while similar poles repel. Thus, the first and second magnets 118, 120 are arranged as depicted in FIG. 3, where the first magnet 118 with a north pole 119 on an outer side 122 of the first temple 108 attracts a south pole 121 on an inner side 124 of the second magnet 120. In other words, the magnetic poles 119, 121 of the magnets 118, 120 are the same on both outer sides 122 of the temples 108, 110 and the magnetic poles 119, 121 of the magnets 118, 120 are the same on both inner sides 124 of the temples 108, 110. In one example, the magnets 118, 120 are arranged with north poles 119 on the outer sides 122 of the temples 118, 120 and south poles 121 on the inner sides 124 of the temples (see FIG. 3). In another example, the magnets 118, 120 are arranged with south poles 121 on the outer sides 122 of the temples 108, 110 and north poles 119 on the inner sides 124 of the temples 108, 110. In either example, opposite poles attract when the temples 108, 110 are pivoted into a closed position without regard to which temple is closer to the frame 104, the attraction exerting a closing force on each of the two or more pairs of magnets 116.

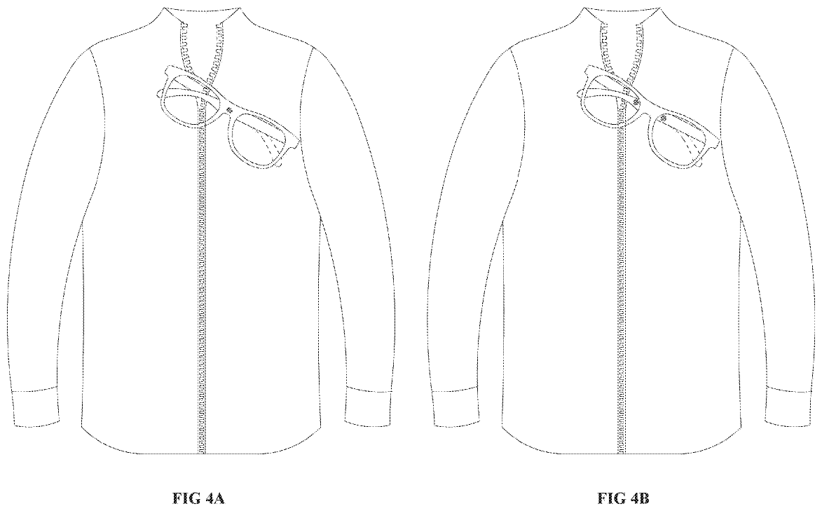

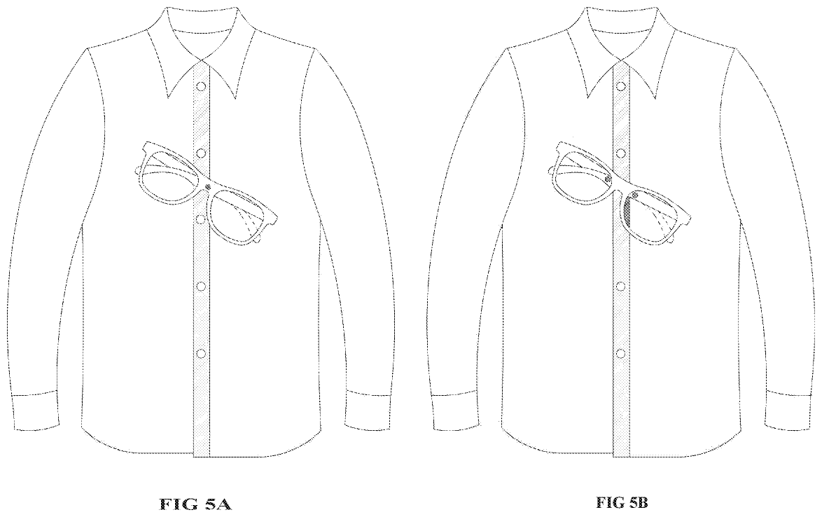

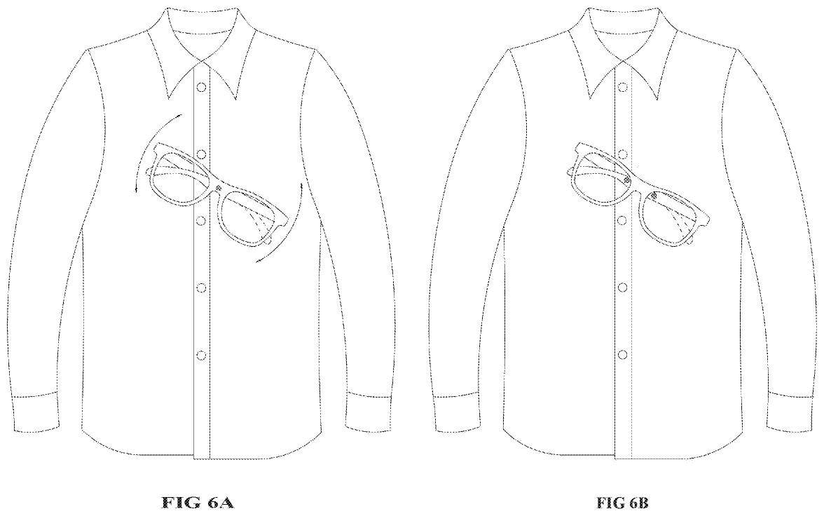

It is therefore an advantage that the eyewear with a multiple fastening mechanism of the instant invention (see FIG. 4B and FIG. 5B) is more securely attached to a user's article of clothing than eyewear with just a single fastening mechanism (see FIG. 4A and FIG. 5A). The closing force for a single pair of magnets, for example, diminishes when said pair of magnets are aligned through a thicker portion of the clothing, such as for example through the zipper of a jacket (FIG. 4A) or through thicker areas of certain novelty button down shirts (FIG. 5A). This, in turn, causes the eyewear to rotate and become unstable (see FIG. 6A). In sharp contrast, eyewear with two or more pairs of fastening means, such as for example two or more pairs of magnets, affords more stability to the eyewear secured through a zipper on an article of clothing or thicker areas of clothing material, in part because at least one pair of said magnets align through a thinner area of said article of clothing (see FIG. 4B, FIG. 5B and FIG. 6B), but also in part because the eyewear benefits from the closing force of two or more pairs of magnets. The eyewear with a multiple fastening mechanism therefore overcomes the deficiencies of the prior art.

In a specific non-limiting embodiment, FIGS. 1-6 show eyewear with two pairs of fastening means, preferably two pairs of magnets, attached to or disposed in the temples of the eyewear. According to this embodiment, the two pairs of magnets are provided on either side of a midpoint of the temples, so as to assure that at least one pair of magnets aligns through a thinner area of clothing as depicted in FIG. 6B. Although two pairs of magnets are shown, other numbers of pairs of magnets can be provided, preferably laterally in or on the temples from said two pairs of magnets, such as but not limited to, providing a pair of magnets in or on the earpieces of the temples. Regardless, the two or more pairs of magnets can be positioned at different positions in or on the temples of the eyewear depending on the design of the eyewear. As discussed above, the magnets can be affixed to the temples or molded integrally into the temples. Preferably, the magnets are molded integrally into the temples.

In still another non-limiting embodiment, the invention relates to a method of supporting eyewear on an article of clothing of a user, the method comprising 1) providing eyewear comprising a frame body for receiving two lenses, a first temple pivotally attached to a first end of the frame, a second temple pivotally attached to a second end of the frame, and a multiple fastening mechanism comprising two or more pairs of magnets, wherein each of the two or more pairs of magnets comprises a first magnet attached to or in contact with the first temple and a second magnet attached to or in contact with the second temple; 2) contacting the first temple to an inside portion of the article of clothing; and 3) contacting the second temple on an outside portion of the article of clothing, wherein the moving of step 2) and the moving of step 3) collectively provides that the first and second temples are pivoted inwardly towards each other to a closed position and each first magnet is configured to be positioned adjacent to each second magnet such that a closing force is exerted on each of the two or more pairs of magnets, thereby supporting the eyewear to the article of clothing of the user.

What is claimed is:

1. An eyewear comprising:
a frame body;
a first temple pivotally attached to a first end of the frame;
a second temple pivotally attached to a second end of the frame; and
a multiple fastening mechanism comprising two or more pairs of fastening means, wherein a first part of each of the two or more pairs of fastening means is attached to or in contact with the first temple and a second part of each of the two or more pairs of fastening means is attached to or in contact with the second temple, each first part of each of the two or more pairs of fastening means configured to be positioned adjacent to each second part of each of the two or more pairs of fastening means such that a closing force is exerted on each pair of fastening means relative to each first part and each second part of each two or more pair of fastening means when the first and second temples are pivoted inwardly to a closed position.

2. The eyewear according to claim 1, wherein the two or more pairs of fastening means are two or more pairs of magnets, the first part of each of the two or more pairs of fastening means being a first magnet and the second part of each of the two or more pairs of fastening means being a second magnet.

3. The eyewear according to claim 2, wherein the first magnet of the two or more pairs of magnets is integrated into the first temple and the second magnet of the two or more pairs of magnets is integrated into the second temple.

4. The eyewear according to claim 3, wherein the first magnet of the two or more pairs of magnets is molded integrally into the first temple and the second magnet of the two or more pairs of magnets is molded integrally into the second temple.

5. The eyewear according to claim 2, wherein the eyewear is sunglasses.

6. The eyewear according to claim 4, wherein the two or more pairs of magnets is two pairs of magnets.

7. The eyewear according to claim 6, wherein the first magnet of the two pairs of magnets are provided on either side of a midpoint of the first temple and the second magnet of the two pairs of magnets are provided on either side of a midpoint of the second temple.

8. The eyewear according to claim 1, wherein the frame body is configured to receive two lenses.

9. An eyewear comprising:
a frame body;
a first temple pivotally attached to a first end of the frame;
a second temple pivotally attached to a second end of the frame; and
a multiple fastening mechanism comprising two or more pairs of magnets, wherein each of the two or more pairs of magnets comprises a first magnet attached to or in contact with the first temple and a second magnet attached to or in contact with the second temple, each first magnet is configured to be positioned adjacent to each second magnet such that a closing force is exerted on each of the two or more pairs of magnets when the first and second temples are pivoted inwardly to a closed position.

10. The eyewear according to claim 9, wherein the first magnet of the two or more pairs of magnets is integrated into the first temple and the second magnet of the two or more pairs of magnets is integrated into the second temple.

11. The eyewear according to claim 10, wherein the first magnet of the two or more pairs of magnets is molded integrally into the first temple and the second magnet of the two or more pairs of magnets is molded integrally into the second temple.

12. The eyewear according to claim 10, wherein the eyewear is sunglasses.

13. The eyewear according to claim 11, wherein the two or more pairs of magnets is two pairs of magnets.

14. The eyewear according to claim 13, wherein the first magnet of the two pairs of magnets are provided on either side of a midpoint of the first temple and the second magnet of the two pairs of magnets are provided on either side of a midpoint of the second temple.

15. The eyewear according to claim 9, wherein the frame body is configured to receive two lenses.

16. A method of supporting eyewear on an article of clothing of a user, the method comprising:
1) providing eyewear comprising a frame body, a first temple pivotally attached to a first end of the frame, a second temple pivotally attached to a second end of the frame, and a multiple fastening mechanism comprising two or more pairs of magnets, wherein each of the two or more pairs of magnets comprises a first magnet attached to or in contact with the first temple and a second magnet attached to or in contact with the second temple;
2) contacting the first temple to an inside portion of the article of clothing; and
3) contacting the second temple on an outside portion of the article of clothing,
wherein the moving of step 2) and the moving of step 3) collectively provides that the first temple and the second temple are pivoted inwardly towards each other to a closed position and each first magnet is configured to be positioned adjacent to each second magnet such that a closing force is exerted on each of the two or more pairs of magnets, thereby supporting the eyewear to the article of clothing of the user.
